(19) United States
(12) Patent Application Publication
(10) Pub. No.: US 2007/0143302 A1
(43) Pub. Date: Jun. 21, 2007

(54) Inter-node communication in a distributed system

(76) Inventor: Alan Stone, Morristown, NJ (US)

Correspondence Address: FISH & RICHARDSON, PC, P.O. BOX 1022, MINNEAPOLIS, MN, 55440-1022, US

(21) Appl. No.: 11/316,327

(22) Filed: Dec. 21, 2005

(51) Int. Cl. G06F 17/30

(52) U.S. Cl. 707/10

(57) ABSTRACT

Techniques for enabling services in different nodes of a distributed system to communicate using data elements, each data element including a metadata descriptor having one or more property-value pairs, the enabling including identifying a relationship between a first service and a second service based on a data element provided by each of the first service and the second service.

### CROSS-REFERENCE TO RELATED APPLICATIONS

This application is also related to U.S. application Ser. No. ______, filed Dec. 21, 2005, entitled “Inter-Partition Communication in a Virtualization Environment,” being filed concurrently with the present application, which is also incorporated herein by reference.

### BACKGROUND

This description relates to inter-node communication in a distributed system.

In a service-oriented architecture (SOA) environment, nodes on a network of a distributed system make resources available to other nodes as independent services that the nodes access in a standardized way. Although SOA is commonly identified in its Web services implementation, SOA can be implemented using any service-based technology. Generally, SOAs are formed by loosely coupled, highly interoperable application services. Because these services interoperate over different development technologies (e.g., Java and .NET), the interface definition of each software component is defined in a standards compliant manner to foster reusability.

A basic SOA interaction includes a service consumer and a service provider. The service consumer typically sends a service request message over a network to a service provider and the service provider returns a response message to the service consumer. Each of these messages typically includes sufficient information (e.g., a destination address in the form of a Uniform Resource Locator) to identify the service and/or node to which the message is directed.

### DESCRIPTION OF DRAWINGS

FIG. 1 is a block diagram of a distributed system.

FIG. 2 is a flowchart for a consumer-provider matching algorithm.

FIG. 3 shows a consumer-provider interaction.

### DETAILED DESCRIPTION

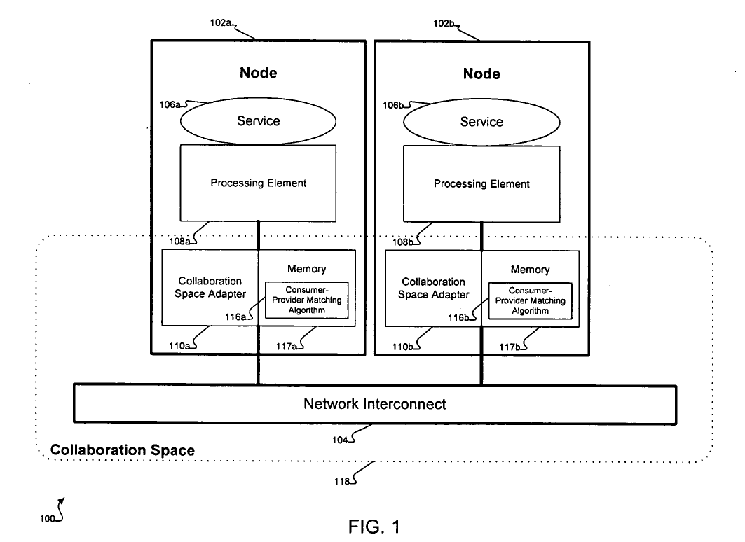

FIG. 1 shows a distributed system 100 of nodes 102a and 102b communicating over a network interconnect 104. Although two nodes are illustratively depicted, any number of nodes can be included in the system. The distributed system may represent a system in a rack, in a chassis, on a board, or on a chip, where the network interconnect 104 is a switched interconnect or a point-to-point interconnect of arbitrary topology. The nodes represent separate physical subsystems that may be of arbitrary size and purpose.

Each node includes one or more processing elements 108a and 108b (e.g., a processor, a field programmable gate array (FPGA), or an application-specific integrated circuit (ASIC)) that implements one or more services 106a in software, hardware, or a hybrid of the two. As with services of a service-oriented architecture, the services of FIG. 1 source, sink, and share data in a way that is platform neutral (e.g., hardware agnostic, programming language agnostic, operating system agnostic, and middleware agnostic). Each service exposes functionality with the following properties: (1) a platform-neutral interface contract to the service that defined the behavior of the service and the messages the service accepts and returns; and (2) the service is self-contained in that it does not depend on the context or state of other services.

Each node includes a collaboration space adaptor 110a and 110b implemented as a combination of hardware and software components. Each hardware component provides an interface between a processing element and the network interconnect, and in some implementations, is integrated within the processing element 108a itself.

Collectively, the software components of the collaboration space adaptors in the various nodes present an intelligent shared memory abstraction for the system of nodes. This shared memory abstraction, also referred to in this description as a collaboration space 118, is logically defined to support the following properties and primitives: (1) memory operations are performed using associative addressing, that is, without physical or virtual addressing; (2) a provider of a service (“service provider”) need not know the destination address of a consumer of the service (“service consumer”) and vice versa; and (3) a service provider need not be running (e.g., spawned or active) at the same time as a service consumer and vice versa.

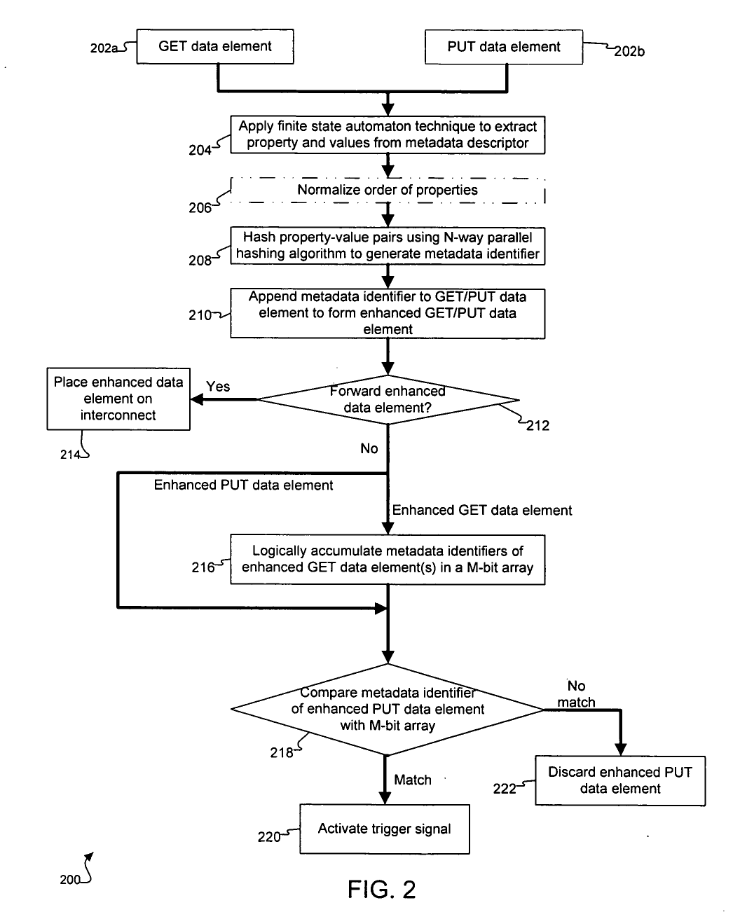

Services 106 of the system collaborate with one another by passing messages to the collaboration space 118, which executes an algorithm (“consumer-provider matching algorithm” 116a described below with reference to FIG. 2) to match service providers with service consumers. In some implementations, these messages represent data elements each having a tag and optionally a payload. The tag includes a metadata descriptor having one or more property-value pairs structured in accordance with a well-formed platform-agnostic schema, such as the XML (eXtensible Markup Language) schema, and the payload includes data content to be shared with other services.

The metadata descriptors represent the mechanism by which two or more services describe, to the collaboration space 118, their intentions to work together in a provider-consumer relationship. Each metadata descriptor takes on one of two roles, namely an attractant or an attractor. When a metadata descriptor is used as an attractant, the data element that is passed to the collaboration space is offered for consumption by another service. When a metadata descriptor is used as an attractor, the data element that is passed to the collaboration space defines the kind of work the service can accomplish. Generally, a match is made between a service provider and a service consumer if a subset of property-value pairs of an attractor metadata descriptor matches the set of property-value pairs of the attractant metadata descriptor.

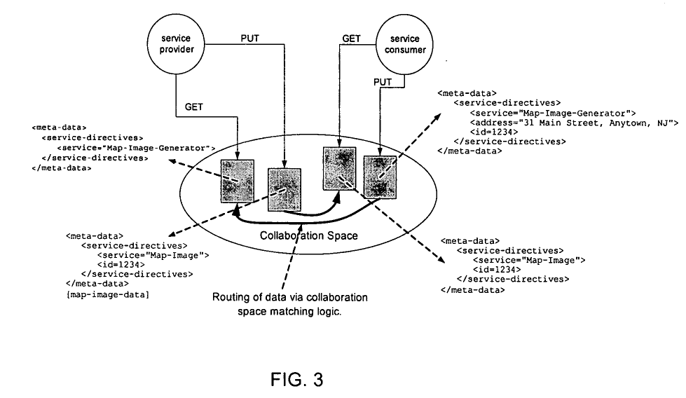

FIG. 2 shows a flowchart for one implementation of the consumer-provider matching algorithm. The flowchart will be described with reference to an example interaction (depicted in FIG. 3) between a service provider that generates map images from a street address provided by a service consumer, and returns the map image to the service consumer.

To start with, the service provider generates a GET data element 202a to advertise the service provider's ability to generate maps (“GET map_request data element”) and passes the GET map_request data element to the collaboration space. In one example, the GET map_request data element has a tag with the following attractor metadata descriptor:

<meta-data>

<service-directives>

<service=“Map-Image-Generator”>

</service-directives>

</meta-data>

The software component of the collaboration space adaptor includes a finite state automaton that extracts (204) the properties and values from the metadata descriptor of the GET map_request data element and outputs a vector of property-value pairs. In some implementations, the software component of the collaboration space adaptor normalizes (206) the property-value pairs prior to passing (208) the property-value pairs through an N-way parallel hashing algorithm, which generates N hashed values referred to in this description as a metadata identifier. This metadata identifier is appended (210) to the GET map_request data element including the metadata descriptor above to generate an enhanced GET map_request data element. In some implementations, the software component of the collaboration space adaptor includes a forwarding algorithm that determines (212) whether the enhanced GET map_request data element is to be forwarded to other nodes of the system 100, and if so, places (214) the enhanced GET map request data element on the network interconnect. The metadata identifiers from the enhanced GET data elements are logically accumulated (216) in a bit array of M bits that is initially zero-valued for all bits. The accumulation of the metadata identifiers is performed by doing a logical OR of the bits represented by the N metadata identifiers' values as offsets into the bit array. The accumulated values of stored metadata identifiers in the bit array lie dormant until a match is made with a metadata identifier of an enhanced PUT data element signifying a consumer-provider match.

Suppose a service consumer wants to obtain a map of “31 Main Street, Anytown, N.J.” The service consumer generates a PUT data element 202b with the map generation service request (“PUT map_request data element”) and passes the PUT map_request data element to the collaboration space 118 for consumption by a map generation service provider. In one example, the PUT map_request data element has a tag with the following attractant metadata descriptor:

<meta-data>

<service-directives>

<service=“Map-Image-Generator”>
<address=“31 Main Street, Anytown, NJ”>
<id=1234>

</service-directives>

</meta-data>

The service consumer also generates a GET data element 202a to pick up the returning map image (“GET map_returned data element”) and passes the GET map_returned data element to the collaboration space. In one example, the GET map_returned data element has a tag with the following attractor metadata descriptor for the returning map image:

<meta-data>

<service-directives>

<service=“Map-Image”>
<id=1234>

</service-directives>

</meta-data>

In one implementation, the collaboration space adaptor uses a finite state automaton technique to extract (204) the properties and values from the metadata descriptors of the PUT map_request data element and the GET map_returned data element and outputs corresponding vectors of property-value pairs, which are each optionally normalized (206) prior to being passed (208) through an N-way parallel hashing algorithm. The metadata identifier represented by each hashed result is appended (210) to the appropriate PUT map_request data element and the GET map_returned data element to generate an enhanced PUT map_request data element and an enhanced GET map_returned data element, respectively. The enhanced data elements may be forwarded (214) to other nodes of the system 100 as previously described.

The collaboration space adaptor then determines whether there is an enhanced GET data element at this node that has a metadata identifier that matches the properties and values of the enhanced PUT map_request data element by performing a logical AND of the metadata identifier of the enhanced PUT map_request data element with the bits of the M-bit array. In instances in which every bit of the result is set, a trigger signal is activated (220) to indicate a match, otherwise, the enhanced PUT map_request data element is discarded (222).

In the example scenario, the activation of the trigger signal results in the routing of the enhanced PUT map_request data element to the service provider, which processes the service request for a map of “31 Main Street, Anytown, N.J.” and generates a PUT data element (“PUT map_returned data element”) having the following attractor metadata descriptor and payload:

<meta-data>

<service-directives>

<service=“Map-Image”>
<id=1234>

</service-directives>

</meta-data>
[map-image-data]

The service provider passes the PUT map_returned data element with the payload of “map-image-data” to the collaboration space to advertise the availability of a map for pick up by a service consumer. The collaboration space adaptor then determines whether there is a suitable attractor waiting in the collaboration space. In this case, the GET map_returned data element is already waiting in the collaboration space to pick up the map image that is returned with the PUT map_returned data element.

The consumer-provider matching algorithm enables the collaboration space adaptor to perform a comparison of a PUT data element with all of the GET data elements in the collaboration space in order(1) time. In so doing, the amount of time it takes to determine if there is a match is always the same regardless of the number of GET data elements, a feature that is particular valuable in the context of arbitrarily scaled systems.

In addition to the inter-service communications described above, the collaboration space 118 may provide additional services specific to the collaboration space (“CS services”) such as encryption policies, replication policies, persistence policies, eviction policies, access control privileges, or other functions. Services optionally parameterize or enable and disable such CS services by including relevant reserved system directives in the metadata descriptors of data elements passed to the collaboration space. Suppose, for example, that the data elements placed in the collaboration space 118 are to be encrypted for security reasons. An optional reserved property such as “encrypt” may be enabled by denoting “TRUE” value (i.e., encrypt=TRUE). The collaboration space adaptor interprets the property-value pairs associated with the service directives and takes appropriate action (in this example, encrypting both the metadata descriptor and the payload of a data element). In this way, the collaboration space is extensible to include such optional features in different implementations. Further, CS services are directly controlled by services without the need to invoke special interfaces. All such communication is simply performed by placing data elements into the collaboration space 118.

Another example of a system that implements techniques for enabling services in different nodes of a distributed system to communicate using data elements, each data element including a metadata descriptor having one or more property-value pairs, the enabling including identifying a relationship between a first service and a second service based on a data element provided by each of the first service and the second service, is set forth in U.S. application Ser. No. ______, Dec. 21, 2005, entitled “Inter-Partition Communication in a Virtualization Environment,” being filed concurrently with the present application, which is also incorporated herein by reference.

The techniques of one embodiment of the invention can be performed by one or more programmable processors executing a computer program to perform functions of the embodiment by operating on input data and generating output. The techniques can also be performed by, and apparatus of one embodiment of the invention can be implemented as, special purpose logic circuitry, e.g., one or more FPGAs (field programmable gate arrays) and/or one or more ASICs (application-specific integrated circuits).

Processors suitable for the execution of a computer program include, by way of example, both general and special purpose microprocessors, and any one or more processors of any kind of digital computer. Generally, a processor will receive instructions and data from a memory (e.g., memory 330). The memory may include a wide variety of memory media including but not limited to volatile memory, non-volatile memory, flash, programmable variables or states, random access memory (RAM), read-only memory (ROM), flash, or other static or dynamic storage media. In one example, machine-readable instructions or content can be provided to the memory from a form of machine-accessible medium. A machine-accessible medium may represent any mechanism that provides (i.e., stores or transmits) information in a form readable by a machine (e.g., an ASIC, special function controller or processor, FPGA or other hardware device). For example, a machine-accessible medium may include: ROM; RAM; magnetic disk storage media; optical storage media; flash memory devices; electrical, optical, acoustical or other form of propagated signals (e.g., carrier waves, infrared signals, digital signals); and the like. The processor and the memory can be supplemented by, or incorporated in special purpose logic circuitry.

Other embodiments are within the scope of the following claims. In some examples, the techniques can be performed in a different order and still achieve desirable results. In some example, one or more of the property-value pairs of a metadata descriptor (attractor or attractant) may include a wildcard property value (e.g., an asterisk (*)) that serves as a substitute for any number of characters. Provision of a wildcard property value (*) enables wildcard matching, rather than exact matching, of property-value pairs to be performed. For example, a metadata descriptor including name=* will be matched with a metadata descriptor including name=“RESET”, a metadata descriptor including name=“LOAD”, and a metadata descriptor including name=“SHUTDOWN”.

What is claimed is:

1. A method comprising:
enabling services in different nodes of a distributed system to communicate using data elements, each data element including a metadata descriptor having one or more property-value pairs, the enabling comprising identifying a relationship between a first service and a second service based on a data element provided by each of the first service and the second service.

2. The method of claim 1, wherein the at least one property-value pair is structured in accordance with a schema.

3. The method of claim 2, wherein the schema comprises a XML schema.

4. The method of claim 1, wherein the data element provided by the first service comprises an attractor metadata descriptor.

5. The method of claim 1, wherein the data element provided by the second service comprises an attractant metadata descriptor.

6. The method of claim 1, wherein the enabling comprises:
receiving one of the data elements from the first service or the second service; and
processing the metadata descriptor of the one data element to generate a metadata identifier.

7. The method of claim 6, wherein the metadata identifier is logically accumulated with other metadata identifiers in a bit array of M bits.

8. The method of claim 1, wherein the enabling comprises:
extracting the one or more property-value pairs from the metadata descriptor of one of the data elements; and
applying a hash function to the extracted one or more property-value pairs to generate a hash result representative of a metadata identifier.

9. The method of claim 8, wherein the processing further comprises:
normalizing properties of the extracted one or more property-value pairs.

10. The method of claim 1, wherein the identifying comprises:
comparing the data element provided by the first service with data elements provided by services other than the first service;
identifying a match between the data element provided by the first service and the data element provided by the second service based on the comparison; and
taking an action with respect to the identified match.

11. The method of claim 10, wherein identifying a match comprises identifying a wildcard match between the data element provided by the first service and the data element provided by the second service.

12. The method of claim 1, wherein the data element provided by the first service comprises a PUT data element and the data element provided by the second service comprises a GET data element.

13. The method of claim 1, wherein the identifying is performed in order(1) time.

14. A machine-accessible medium comprising content, which, when executed by a machine causes the machine to:
enable services in different nodes of a distributed system to communicate using data elements, each data element including a metadata descriptor having one or more property-value pairs, wherein the content, which, when executed by the machines causes the machine to identify a relationship between a first service and a second service based on a data element provided by each of the first service and the second service.

15. The machine-accessible medium of claim 14, further comprising content, which when executed by the machine causes the machine to:
compare the data element provided by the first service with data elements provided by services other than the first service;
identify a match between the data element provided by the first service and the data element provided by the second service based on the comparison; and
take an action with respect to the identified match.

16. A method comprising:
enabling a service in a node of a distributed system to control one or more parameters of a collaboration space by passing a data element to the collaboration space, the data element comprising a metadata descriptor defining at least one service directive of the collaboration space.

17. The method of claim 16, wherein the at least one service directive comprises a property-value pair.

18. The method of claim 16, wherein the at least one service directive is associated with one or more of the following: an encryption policy, a replication policy, a persistence policy, an eviction policy, and an access control privilege policy.

19. A node comprising:
a processing element;
a memory including a collaboration space software to provide instructions to the processing element to:
enable a service in the node to communicate with another service using data elements, each data element including a metadata descriptor having one or more property-value pairs, the enabling comprising identifying a relationship between a first service and a second service based on a data element provided by each of the first service and the second service.

20. The node of claim 19, further to provide instructions to:
compare the data element provided by the first service with data elements provided by services other than the first service;
identify a match between the data element provided by the first service and the data element provided by the second service based on the comparison; and
take an action with respect to the identified match.

21. The node of claim 19, wherein the data element provided by the first service has a first set of property-value pairs and the data element provided by the second service has a second set of property-value pairs, the first set being a subset of the second set.

22. A system comprising:
nodes in communication using an interconnect, each node comprising a service and a collaboration space adaptor, the collaboration space adaptors collectively providing a collaboration space for the system that enables services in different nodes to communicate using data elements, each data element including a metadata descriptor having one or more property-value pairs, the enabling comprising identifying a relationship between a first service and a second service based on a data element provided by each of the first service and the second service.

23. The system of claim 22, wherein each node further comprises a processing element that implements a service in software, hardware, or both.

24. The system of claim 22, wherein the collaboration space enables services in different nodes to communicate through memory operations that are performed using associative addressing.

25. The system of claim 22, wherein the collaboration space enables the first service and the second service to communicate without either service knowing a destination address of the other service.

26. The system of claim 22, wherein the collaboration space enables the first service and the second service to communicate without requiring both services to be run at the same time.
